(19) United States
(12) Patent Application Publication
(10) Pub. No.: US 2014/0074737 A1
(43) Pub. Date: Mar. 13, 2014

(54) SCREENING AND MONITORING DATA TO ENSURE THAT A SUBJECT ENTITY COMPLIES WITH LAWS AND REGULATIONS

(71) Applicant: THE DUN & BRADSTREET CORPORATION, Short Hills, NJ (US)

(72) Inventors: Kelvin DICKENSON, Huntington, NY (US); Deepika LAROIA, Far Hills, NJ (US); Dean STACK, Bethlehem, PA (US); Sean PURSLEY, Hoboken, NJ (US); Raj BATRA, North Brunswick, NJ (US); William MORGAN, Easton, PA (US)

(73) Assignee: THE DUN & BRADSTREET CORPORATION, Short Hills, NJ (US)

(21) Appl. No.: 14/026,843

(22) Filed: Sep. 13, 2013

Related U.S. Application Data
(60) Provisional application No. 61/700,676, filed on Sep. 13, 2012.

(51) Int. Cl. G06Q 30/00

(52) U.S. Cl. CPC G06Q 30/018
USPC 705/317

(57) ABSTRACT

There is provided a method that includes (a) receiving an electronic communication that includes a description of a subject entity, (b) matching the input record to data in a first database, where the data includes an identifier of the subject entity, (c) generating a consolidated input that includes the description and the identifier, (d) searching a second database for adverse information concerning the subject entity, based on the consolidated input (e) producing a result that indicates whether the searching yielded the adverse information, and (f) issuing, by way of an electronic communication, a report that includes the result. There is also provided a system that performs the method, and a storage device that contains instructions for controlling a processor to perform the method.

### CROSS-REFERENCE TO RELATED APPLICATIONS

The present application is claiming priority of U.S. Provisional Patent Application Ser. No. 61/700,676, filed on Sep. 13, 2012, the content of which is herein incorporated by reference.

### BACKGROUND OF THE DISCLOSURE

1. Field of the Disclosure

The present disclosure generally relates to a system and method for providing to an organization, advanced screening and monitoring of customer and supplier business practices to ensure global regulatory compliance with a range of global anti-fraud and corruption regulations. In particular, unique aspects of the system and method are: (1) a unique assembler that expands a conventional input record by appending principal and entity data thereto; (2) a unique change detection process, i.e., monitor the input records for any change in principal or related entity data); and (3) a unique technique for generating a consolidated assessment report, including screening for adverse records and events. The system and method of the present disclosure assists a requestor, i.e., a user making a request, in identifying banned or suspect entities and individuals, strengthening fraud protection, ensuring regulatory compliance, managing supply and distribution risk, and protecting the requestor's brand.

2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

A company moving into a global market may have limited visibility into new supplier/partner processes and regional business practices. The company can easily be at risk for violating a broad range of regulations that are proliferating worldwide.

Such a company, when considering transacting business with a subject entity, may be obligated to also consider whether the subject entity is in compliance with various laws and regulations. However, the subject entity may be a shell organization having no history of any direct adverse activity, but is nevertheless related to a business, e.g., a subsidiary, that has been engaged in adverse activity. In such a case, a decision of whether to transact business with the subject entity should consider the adverse activity of the related business, but a review of the subject entity alone will not reveal the adverse activity.

Additionally, data concerning adverse activity is not centralized, but instead, is found in a plurality of unrelated data sources. Therefore, in order for the company to obtain a complete picture of the activities engaged in by the subject entity, the company would need to search the plurality of unrelated data sources.

There is a need for a system and a method that a requestor can employ to obtain accurate, timely information about a subject entity's compliance with laws and regulations, and in particular for a case where data concerning the subject entity and data concerning its related businesses are dispersed over a plurality of separate, independent databases.

### SUMMARY OF THE DISCLOSURE

The present disclosure describes a compliance solution that provides a requestor with advanced screening and monitoring of a customer and/or a supplier, thereby facilitating the requestor's compliance with global anti-corruption, Anti Money Laundering (AML), Global Bribery & Corruption, and Alcohol Tobacco & Firearms (ATF) export controls and sanctions regulations. It allows the requestor to identify banned, suspect or higher-risk entities, strengthen fraud protection, ensure regulatory compliance, manage supply and distribution risk, and protect brand equity. In addition, the present disclosure enables the requestor to access data and insight on more than 210 million companies, 10 million people, 900 industries and three million corporate family trees, along with integrated social data from influential social platforms. Leveraging multiple databases, including global watch lists, regulatory authority actions, law enforcement sources, and global news sources, updated daily, the requestor has a comprehensive and broad-reaching compliance solution to address all compliance program needs.

Key advantages of the present disclosure include:
(1) Uncovering Hidden Risk: Mitigating risk throughout a value chain by assessing complete risk in a corporate family, including individuals, not just a single entity.
(2) Improving Efficiency: Saving time and money by leveraging integrated databases to gain a broad and complete screen while at the same time reducing and/or eliminating false-positives of data points, returning only alerts that matter to a unique business based on a risk event code, an event stage, an age of alert, an entity type, and a match score.
(3) Objective, Fact-based Guidance: Leveraging source data from more than 10,000 media organizations to stay abreast of global adverse events, including information on the organizations, and owners and executive management within a requestor's network of suppliers, partners and customers.

The present disclosure provides a suite of solutions designed to help a requestor better manage risk and compliance in an increasingly complex world stage of commerce. By leveraging insights, intelligence and automation, the suite will include solutions that address regulatory compliance, fraud avoidance, diversity and corporate social responsibility objectives, supplier certification/due diligence and reputational/ethics risk.

There is thus provided a method performed by a processor, where the method includes (a) receiving an electronic communication that includes a description of a subject entity, (b) matching the input record to data in a first database, where the data includes an identifier of the subject entity, (c) generating a consolidated input that includes the description and the identifier, (d) searching a second database for adverse information concerning the subject entity, based on the consolidated input (e) producing a result that indicates whether the searching yielded the adverse information, and (f) issuing, by way of an electronic communication, a report that includes the result. There is also provided a system that performs the method, and a storage device that contains instructions for controlling a processor to perform the method.

In accordance with the system and method described herein, a requestor can obtain accurate, timely information about a subject entity's compliance with laws and regulations, and in particular for a case where data concerning the subject entity and data concerning its related businesses are dispersed over a plurality of separate, independent databases.

### BRIEF DESCRIPTION OF THE DRAWINGS

FIG. 1 is a block diagram of a system for monitoring corporate regulatory compliance.

FIG. 2 is a flowchart of a method for monitoring corporate regulatory compliance.

A component or a feature that is common to more than one drawing is indicated with the same reference number in each of the drawings.

### DESCRIPTION OF THE DISCLOSURE

The system and method of the present disclosure enables a requestor to meet global anti-corruption regulations, such as anti-money laundering and the USA Patriot Act, the Foreign Corrupt Practices Action (FCPA), the UK Bribery Action, Office of Foreign Assets Control (OFAC)/Restricted party sanctions, and International Traffic in Arms Regulations (ITAR). By appending principal and related entity data to data collected by requestors to form enhanced data and thereafter screening such enhanced data against global adverse information data on organizations, owners and executive management, a requestor is provided with previously unavailable insight on business entities to widen a scope of adverse/watch list screens, combined with screening and monitoring, thereby greatly reducing false positives.

DUNS is a system developed and regulated by Dun & Bradstreet Corp. (D&B) that assigns a unique numeric identifier, referred to as a DUNS number, to a single business entity. Thus, a given DUNS number uniquely identifies a particular business. It is a common standard worldwide. DUNS users include the European Commission, the United Nations and the United States government.

A requestor's corporate input records, or a requestor's supplier's corporate input records, are submitted by the requestor for screening, where the records are enriched by appending or adding principal and related entity data thereto, e.g. name of chief executive officer (CEO), a unique corporate identifier (e.g., a DUNS Number), a legal name, principals, and corporate family linkage information). Thereafter, the appended input records are screened against a database of adverse items (i.e., an entity on a sanction list (e.g., OFAC, Central Intelligence Agency (CIA), Debarments, etc.), an enforcement action by a regulator (e.g., a fine or investigation), the presence of a politically exposed person (PEP), a connection to Iran based on research or news articles from a number of global media sources (e.g., the CEO of ABC Company was arrested for bribery)). The newly screened appended input records are monitored for any new adverse data that may be added, and alert of any such new matches is issued to the requestor.

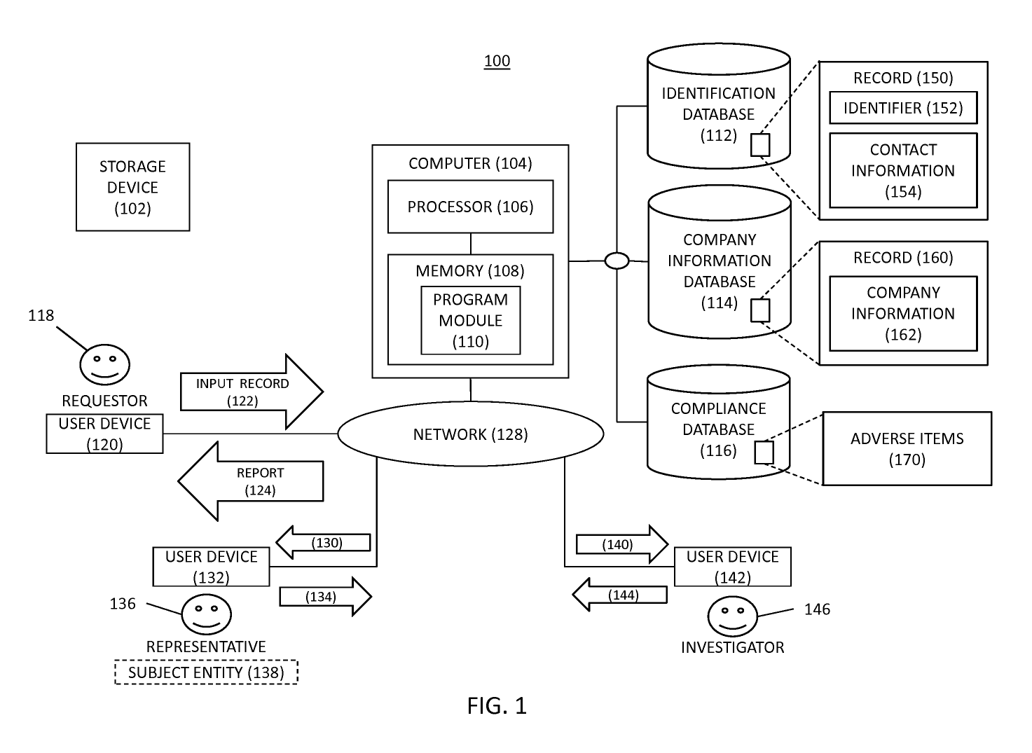

FIG. 1 is a block diagram of a system 100 for monitoring corporate regulatory compliance. System 100 includes a computer 104, and user devices 120, 132 and 142, each of which is communicatively coupled to a network 128, e.g., the Internet. Communications conducted via network 128 are by way of electronic or optical signals.

Computer 104 includes a processor 106, and a memory 108 coupled to processor 106. Although computer 104 is represented herein as a standalone device, it is not limited to such, but instead can be coupled to other devices (not shown) via a local network (not shown) or via network 128, in a distributed processing system.

Processor 106 is an electronic device configured of logic circuitry that responds to and executes instructions.

Memory 108 is a tangible computer-readable storage device. In this regard, memory 108 stores data and instructions, i.e., program code, that are readable and executable by processor 106 for controlling the operation of processor 106. Memory 108 may be implemented in a random access memory (RAM), a hard drive, a read only memory (ROM), or a combination thereof. One of the components of memory 108 is a program module 110.

Program module 110 contains instructions for controlling processor 106 to perform a method for monitoring corporate regulatory compliance, as described herein.

The term “module” is used herein to denote a functional operation that may be embodied either as a stand-alone component or as an integrated configuration of a plurality of subordinate components. Thus, program module 110 may be implemented as a single module or as a plurality of modules that operate in cooperation with one another. Moreover, although program module 110 is described herein as being installed in memory 108, and therefore being implemented in software, it could be implemented in any of hardware (e.g., electronic circuitry), firmware, software, or a combination thereof.

While program module 110 is indicated as being already loaded into memory 108, it may be configured on a storage device 102 for subsequent loading into memory 108. Storage device 102 is a tangible computer-readable storage device that stores a version of program module 110 thereon. Examples of storage device 102 include a compact disk, a magnetic tape, a read only memory, an optical storage media, a hard drive or a memory unit consisting of multiple parallel hard drives, and a universal serial bus (USB) flash drive. Alternatively, storage device 102 can be a random access memory, or other type of electronic storage device, located on a remote storage system (not shown) and coupled to computer 104 via network 128.

System 100 also includes an identification database 112, a company information database 114, and a compliance database 116, each of which is communicatively coupled to computer 104.

Identification database 112 contains records, each of which identifies a business entity and includes contact data for the business entity. If the business entity has an associated DUNS number, then the record for that business entity also includes the DUNS number. FIG. 1 shows an exemplary record, i.e., a record 150, in identification database 112. Record 150 includes an identifier 152 and contact information 154. The significance of record 150 and its contents is described further below.

Company information database 114 contains records that describe various aspects of businesses that have an associated DUNS number. Thus, given a DUNS number, processor 106 can retrieve, from company information database 114, a record that contains information about a business entity that is identified by the DUNS number. Company information database 114 contains company information such as the name of the CEO, names of principals, and corporate linkage.

Corporate linkage is a data structure that links records of related business entities in company information database 114 by way of their DUNS numbers. Thus, processor 106 can utilize the DUNS number of a particular business entity to traverse the corporate linkage data structure to identify business entities that are related to the particular business entity, such as, a parent corporation, a subsidiary, or a branch office, in a family tree. In this regard, processor 106 can identify all of the business entities in a particular family tree, from top to bottom.

FIG. 1 shows an exemplary record, i.e., a record 160, in company information database 114. Record 160 includes company information 162. The significance of record 160 and its contents is described further below.

Compliance database 116 is a database of adverse items, as mentioned above, such as sanctioned entities, regulatory actions, criminal actions, politically exposed persons, Iranian connections, and adverse events from media sources, e.g., news sources. FIG. 1 shows an exemplary set of adverse items, i.e., adverse items 170, in compliance database 116. The significance of adverse items 170 is described further below.

Although each of identification database 112, company information database 114 and compliance database 116 is shown in FIG. 1 as being directly coupled to computer 104, these databases can be located remotely from computer 104, and remotely from one another, and coupled to computer 104 via a network, such as network 128. Additionally, although in FIG. 1 each of identification database 112, company information database 114, and compliance database 116 is shown by a single database symbol, each of them may configured as a plurality of separate databases on a plurality of storage devices. For example, compliance database 116 may be configured as a plurality of separate, independent databases, on separate, independent storage devices. Furthermore, in practice, each of identification database 112 and company information database 114 may contain millions of records. Compliance database 116 may also contain a very large number of records. Given the size and possible geographic dispersion of these databases, manual searching for information contained therein would be impractical, if not impossible.

User devices 120, 132 and 142 are used by a requestor 118, a representative 136, and an investigator 146, respectively. Thus, each of requestor 118, representative 136, and investigator 146 is, generally speaking, a user if his/her respective user device 120, 132 and 142.

Requestor 118 is a person who wishes to obtain information about a subject entity 138, i.e., a business entity or an individual, with which requestor 118 is considering engaging in a business transaction.

Representative 136 is a person who represents subject entity 138. If subject entity 138 is a business, representative 136 might be an employee of the business, or an agent acting on behalf of the business. If subject entity 138 is an individual, representative 136 might be the individual, or an agent acting on behalf of the individual.

Investigator 146 is a person who is a third-party that has an ability to conduct an independent investigation of subject entity 138. Thus, investigator 146 in not affiliated with subject entity 138.

Each of user devices 120, 132 and 142 includes an input device, such as a keyboard or speech recognition subsystem, for enabling its respective user to communicate information and command selections to, and receive communications and processing results from, computer 104 via network 128. Each of user devices 120, 132 and 142 also includes an output device such as a display, a printer, or a speech synthesizer. A cursor control such as a mouse, track-ball, or touch-sensitive screen, allows its user to manipulate a cursor on the display for communicating additional information and command selections to computer 104. An exemplary embodiment of user devices 120, 132 and 142 is a desk-top computer.

User device 120 communicates with computer 104 via network 128. For example, user device 120 sends, and computer 104 receives, an input record 122, and computer 104 sends, and user device 120 receives, a report 124.

User device 132 communicates with computer 104 via network 128. For example, computer 104 sends, and user device 132 receives, a communication 130, and user device 132 sends, and computer 104 receives, a communication 134.

User device 142 communicates with computer 104 via network 128. For example, computer 104 sends, and user device 142 receives, a communication 140, and user device 142 sends, and computer 104 receives, a communication 144.

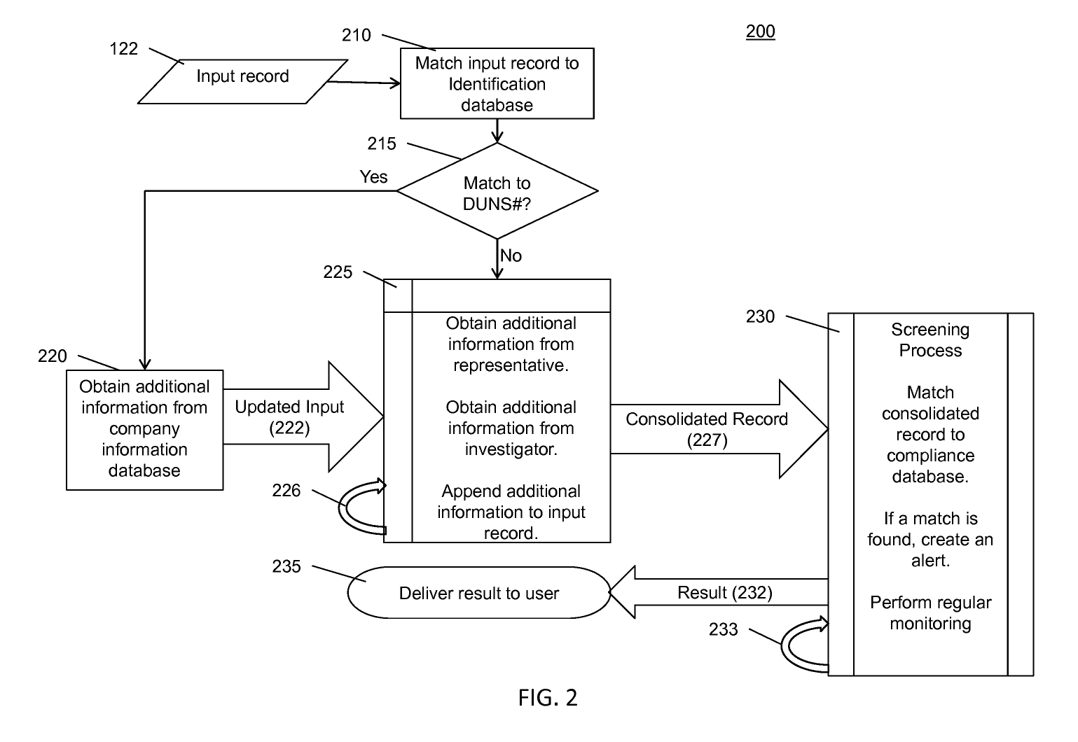

FIG. 2 is a flowchart of a method 200 for monitoring corporate regulatory compliance. Method 200 is executed by computer 104, and more particularly processor 106 in accordance with instructions in program module 110. As mentioned above, requestor 118 wishes to obtain information about subject entity 138, and subject entity 138 is represented by representative 136. Method 200, which is also referred to herein as an “assembler”, commences with step 210.

In step 210, processor 106 receives input record 122 from user device 120, and matches input record 122 to data in identification database 112. Input record 122 contains a description of subject entity 138, which includes at least a name of subject entity 138. Preferably, the description also includes other information that might help to identify subject entity 138, such as subject entity 138's address or place of business. Matching, as used herein, means searching a data storage device for data that best matches a given inquiry, e.g., searching identification database 112 for a record that best matches input record 122. Thus, the more accurate and more thorough the description in input record 122, the more likely that processor 106 will find a correct match to a record in identification database 112. In step 210, processor 106 finds a single best match of input record 122 to a record in identification database 112.

By way of example, assume that requestor 118 is seeking information about a business entity, and in input record 122 includes the business name “ABC Corp.” and the address “123 Main Avenue, Sampletown, N.Y.” In step 210, processor 106 may match input record 122 to a record in identification database 112 for “ABC Corporation” which is located at 123 Main Street, Sampletown, N.Y.

another example, assume that requestor 118 is seeking information about an individual, and in input record 122 includes the name “John Doe”, and the address “123 Main Avenue, Sampletown, N.Y.” Assume also that John Doe is the president of ABC Corporation, but that input record 122 does not include this information. However, identification database 112 includes a record that indicates that that John Doe is the president of ABC Corporation, 123 Main Street, Sampletown, N.Y. Accordingly, in step 210, processor 106 may match input record 122 to the record in identification database 112 for “ABC Corporation” which is located at 123 Main Street, Sampletown, N.Y.

For purpose of example, assume that in step 210, the input record 122 is matched to record 150. Thus, identifier 152 is an identifier of subject entity 138, and contact information 154 is contact information for subject entity 138. Assume also that identifier 152 is a DUNS number.

From step 210, method 200 progresses to step 215.

In step 215, processor 106 considers the result of the matching operation performed in step 210. If a match is made to a record in identification database 112 that includes a DUNS number, then method 200 progresses to step 220. If a match is made to a record in identification database 112 that does not include a DUNS number, then method 200 progresses to step 225.

In the example where identifier 152 is a DUNS number, method 200 will progress to step 220.

In step 220, processor 106 utilizes the DUNS number and based thereon, searches company information database 114 and obtains information about the business entity that is identified by the DUNS number. Thereafter, processor 106 adds, to input record 122, the information obtained from identification database 112 and the information obtained from company information database 114, thus yielding updated input 222.

By way of example, assume that processor 106 accesses record 160 and obtains company information 162, and that company information 162 includes the name of the CEO of subject entity 138, and also includes corporate linkage to a business entity that is related to subject entity 138. Accordingly, updated input 222 will include the content of record 150 and the content of record 160, and in this case, identifier 152, contact information 154, and company information 162.

From step 220, method 200 progresses to step 225.

In step 225, processor 106 has thus far received input record 122, acquired data from identification database 112, and possibly acquired information from company information database 114. Based on this assortment of information, processor 106 engages in correspondences with each of representative 136 and investigator 146, to obtain additional information about subject entity 138. Based on this total collection of information, that is data from input record 122, identification database 112, company information database 114 (if available), representative 136 and investigator 146, processor 106 will produce a consolidated record 227.

As mentioned above, representative 136 is a representative of subject entity 138. By way of communication 130, processor 106 requests, from representative 136, additional information about subject entity 138. By way of communication 134, representative 136 provides this additional information. Communications 130 and 134 can be in any suitable form, for example, emails.

As mentioned above, investigator 146 is a third-party that has an ability to conduct an independent investigation of subject entity 138. For example, if subject entity 138 is a business in Mexico, investigator 146 could be a person in Mexico that can visit the business in Mexico.

By way of communication 140, processor 106 requests that investigator 146 perform an investigation of subject entity 138, to obtain additional information. By way of communication 144, investigator 146 provides this additional information. Communications 140 and 144 can be in any suitable form, for example, emails.

As mentioned above, based on the total collection of information, processor 106 will produce consolidated record 227. Accordingly, consolidated record 227 may include information from each of input record 122, identification database 112, company information database 114, communication 134, and communication 144.

From step 225, method 200 progresses to step 230.

In step 230, processor 106 performs a screening process utilizing compliance database 116, based on information provided in consolidated record 227. That is, based on consolidated record 227, processor 106 will access compliance database 116, and determine whether subject entity 138 or any of its related businesses has engaged, or is suspected of having engaged, in any adverse activity. The screening process matches the data from consolidated record 227 to a universe of adverse data in compliance database 116 that may include sanctioned entities, regulatory actions, criminal database, politically exposed persons, Iranian connections and adverse events from medial sources.

For the screening of subject entity 138, assume that processor 106 matches the data from consolidated record 227 to adverse items 170. Processor 106 prepares a result of the screening process, i.e., a result 232, and if any adverse activity is found, processor 106 includes an alert in result 232. Thus, result 232 may indicate that subject entity is not known to be involved in any adverse activity, or result 232 may include an alert that indicates subject entity is known to be, or suspected to be, involved in some adverse activity. If adverse activity is known or suspected, result 232 will include details about the adverse activity. From step 230, method 230 progresses to step 235.

In step 235, processor 106 sends result 232 to user device 120 in report 124.

Each of steps 225 and 230 are periodically re-executed, as indicated by processing loops 226 and 233, respectively.

During the periodic re-execution of step 225, processor 106 monitors identification database 112 and company information database 114 for any changes in CEO, legal name, or parent company for subject entity 138 and its related businesses, and if any change is detected, processor 106 updates consolidated record 227, and invokes another execution of step 230.

During the periodic re-execution of step 230, processor 106 monitors compliance database 116 for any change, and it a change is detected, issues a updated result 232, and invokes another execution of step 235, in which processor 106 sends the updated result 232 to user device 120 in report 124.

As mentioned above, consolidated record 227 may include information from each of input record 122, identification database 112, company information database 114, communication 134, and communication 144. Consolidated record 227, rather than being a record that actually holds the aforementioned information, may be configured with pointers to relevant data in identification database 112 and company information database 114. In either case, consolidated record 227 provides processor 106 with an ability to readily access information of interest. Thus, appending data to consolidated record 227, or including data in consolidated record 227 means generating consolidated record 227 in a form that enables processor 106 to access the data.

Consolidated record 227 is thus a data structure, produced processor 106, similar to that of a virtual social network, through which information in identification database 112 and company information database 114, concerning subject entity 138, are linked to one another. Given such links, processor 106 can search for relationships between the entities. Among the technical benefits of method 200 is that it facilitates the development of consolidated record 227 for a plurality of subject entities such as subject entity 138, which in turn enables expedited searching for relationships, and increases the speed and accuracy of such searches as compared to solutions in the prior art.

Compliance database 116 includes information from a plurality of sources, several of which are described below.

Compliance database 116 includes global media/negative news collected from many, e.g., thousands, of individual media sources, e.g., newspapers, magazines, trade specialty publications, geographic special interest publications, academic journals, gray literature, and television and radio transcripts. Foreign-language material from domestic and overseas US government bureaus is used after translating to English.

Compliance database 116 includes government, sanctions and regulatory lists include hundreds of regulatory and disciplinary authority and government lists including, but not limited to fugitive lists, exclusions lists, global sanctions lists, fraud warnings, debarment lists, disciplinary actions, enforcement actions and law enforcement press releases. Thorough coverage of US and international sanctions and securities exchange actions includes, but is not limited to, data from OFAC, the Office of the Superintendent of Financial Institutions (OSFI), the Department of Foreign Affairs and Trade DFAT, Japan Finance Ministry, Bank of England, and Hong Kong Monetary Authority.

Compliance database 116 includes detailed, open sourced profiles of Iran-relevant entities and the associated individuals and organizations tied to those entities kept current as new information or details emerge.

PEP Connect™ includes fully sourced profiles of senior officeholders, military officials, judicial figures, state controlled enterprise directors, regional and municipal officials, legislators, and political party leaders. Also, names, aliases, DOBs, potion history are included in each record. Also, links to profiles of family members and close associates. Finally, assembled from extensive, quality-controlled and validated global English and foreign language sources.

Thus, method 200 is a method for monitoring corporate regulatory compliance, and includes screening enhanced commercial information that includes appending principal (e.g., owners and executive management) and entity data to corporate input records, wherein the screening is conducted via a global regulatory information database, i.e., compliance database 116. Compliance database 116 comprises known or suspected corrupt private and public sector figures, fraudsters, illicit financiers, money launderers, organized crime groups, terrorist organization, politically exposed persons and dozens of other risk relevant categories of persons and organizations.

Method 200 includes enhancing corporate input records to include officers and related entities, rather than input data collected solely from users, and screening this enhanced data set to meet a wide range of compliance requirements that may include global anti-corruption (AML, Bank Secrecy Act (BSA), OFAC, ITAR, FCPA, UK Bribery Act, etc.). Optionally, the enhanced data set is monitored for any change in principal or related entity (i.e. parent company) and if such change occurs (e.g., a new CEO is appointed), re-screening such changed records via the global regulatory information database, thereby increasing the number of entities screened and monitored for the purpose of regulatory compliance.

Method 200 also includes expanding the input record prior to screening activity by way of appending additional related entity names provided by a third party (i.e., not supplied along with the input records) for the express purpose of a more comprehensive and inclusive screening process. Method 200 also includes, monitoring the records for new third party names to be screened and submitting such names for screening.

In review, method 200 is performed by processor 106 in accordance with program module 110, i.e., instructions in memory 108, and method 200 includes:
(a) receiving an electronic communication that includes input record 122, which includes a description of subject entity 138;
(b) matching input record 122 to data in identification database 112, where the data includes identifier 152, i.e., an identifier of subject entity 138;
(c) generating consolidated record 227, which includes the description and identifier 152;
(d) searching compliance database 116 for adverse information concerning subject entity 138;
(e) producing result 232, which indicates whether the searching yielded the adverse information; and
(f) transmitting an electronic communication, i.e., report 124, which includes result 232.

Method 200 also includes, in a case where identifier 152 is a DUNS number:
obtaining, from company information database 114, based on the DUNS number, company information 162, i.e., additional information concerning subject entity 138; and
including company information 162 in consolidated record 227.

Method 200 also includes:
monitoring the data in identification database 112 and the adverse information in compliance database 116;
detecting a change in either of the data or the adverse information;
generating an updated result 232 that indicates the change; and
transmitting an updated report 124, that includes the updated result 232.

System 100, as compared to prior art systems, provides for an increase in speed and improved accuracy, in the analysis of data concerning the compliance of subject entity 138. Also, the recurring operation of steps 225 and 230 provide for a more timely reporting of changes and recent activity on the part of subject entity 138 and its related businesses.

The techniques described herein are exemplary, and should not be construed as implying any particular limitation on the present disclosure. It should be understood that various alternatives, combinations and modifications could be devised by those skilled in the art. For example, in practice, system 100 may service a plurality of parties similar to requestor 118 that wish to obtain information about a plurality of parties similar to subject entity 138, and to do so, system 100 may also employ the services of a plurality of parties similar to investigator 146. Accordingly, computer 104 would engage in communications with any suitable quantity of user devices such as user devices 120, 132 and 142. Steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method, performed by a processor in accordance with instructions in a memory device, comprising:
receiving an electronic communication that includes an input record that includes a description of a subject entity;
matching said input record to data in a first database, wherein said data includes an identifier of said subject entity;
generating a consolidated input that includes said description and said identifier;
searching a second database for adverse information concerning said subject entity, based on said consolidated input;
producing a result that indicates whether said searching yielded said adverse information; and
transmitting an electronic communication that includes said result.

2. The method of claim 1, wherein said identifier is a Data Universal Numbering System (DUNS) number.

3. The method of claim 2, further comprising:
obtaining, from a third database, based on said DUNS number, additional information concerning said subject entity; and
including said additional information in said consolidated input.

4. The method of claim 3,
wherein said additional information identifies a business entity that is related to said subject entity in a family tree, and
wherein said adverse information includes adverse information concerning said business entity.

5. The method of 3, further comprising,
monitoring said data in said first database and said adverse information;
detecting a change in either of said data or said adverse information;
generating an updated result that indicates said change; and
transmitting an electronic communication that includes said updated result.

6. The method of claim 3, further comprising:
transmitting an electronic communication that includes a request for a representative of said subject entity to provide first requested information about said subject entity;
receiving an electronic communication that includes said first requested information;
transmitting an electronic communication that includes a request for an investigator that is not affiliated with said subject entity to provide second requested information about said subject entity;
receiving an electronic communication that includes said second requested information; and
including said first requested information and said second requested information in said consolidated input.

7. A system, comprising:
a processor; and
a memory that contains instructions that when read by said processor cause said processor to:
receive an electronic communication that includes an input record that includes a description of a subject entity;
match said input record to data in a first database, wherein said data includes an identifier of said subject entity;
generate a consolidated input that includes said description and said identifier;
search a second database for adverse information concerning said subject entity, based on said consolidated input;
produce a result that indicates whether said searching yielded said adverse information; and
transmit an electronic communication that includes said result.

8. The system of claim 7, wherein said identifier is a Data Universal Numbering System (DUNS) number.

9. The system of claim 8, wherein said instructions also cause said processor to:
obtain, from a third database, based on said DUNS number, additional information concerning said subject entity; and
include said additional information in said consolidated input.

10. The system of claim 9,
wherein said additional information identifies a business entity that is related to said subject entity in a family tree, and
wherein said adverse information includes adverse information concerning said business entity.

11. The system of 9, wherein said instructions also cause said processor to:
monitor said data in said first database and said adverse information;
detect a change in either of said data or said adverse information;
generate an updated result that indicates said change; and
transmit an electronic communication that includes said updated result.

12. The system of claim 9, wherein said instructions also cause said processor to:
transmit an electronic communication that includes a request for a representative of said subject entity to provide first requested information about said subject entity;
receive an electronic communication that includes said first requested information;
transmit an electronic communication that includes a request for an investigator that is not affiliated with said subject entity to provide second requested information about said subject entity;
receive an electronic communication that includes said second requested information; and
include said first requested information and said second requested information in said consolidated input.

13. A tangible storage device comprising instructions that when read by a processor, cause said processor to:
receive an electronic communication that includes an input record that includes a description of a subject entity;
match said input record to data in a first database, wherein said data includes an identifier of said subject entity;
generate a consolidated input that includes said description and said identifier;
search a second database for adverse information concerning said subject entity, based on said consolidated input;
produce a result that indicates whether said searching yielded said adverse information; and
transmit an electronic communication that includes said result.

14. The tangible storage device of claim 13, wherein said identifier is a Data Universal Numbering System (DUNS) number.

15. The tangible storage device of claim 14, wherein said instructions also cause said processor to:
obtain, from a third database, based on said DUNS number, additional information concerning said subject entity; and
include said additional information in said consolidated input.

16. The tangible storage device of claim 15,
wherein said additional information identifies a business entity that is related to said subject entity in a family tree, and
wherein said adverse information includes adverse information concerning said business entity.

17. The tangible storage device of 15, wherein said instructions also cause said processor to:
monitor said data in said first database and said adverse information;
detect a change in either of said data or said adverse information;
generate an updated result that indicates said change; and
transmit an electronic communication that includes said updated result.

18. The tangible storage device of claim 15, wherein said instructions also cause said processor to:
transmit an electronic communication that includes a request for a representative of said subject entity to provide first requested information about said subject entity;
receive an electronic communication that includes said first requested information;
transmit an electronic communication that includes a request for an investigator that is not affiliated with said subject entity to provide second requested information about said subject entity;
receive an electronic communication that includes said second requested information; and
include said first requested information and said second requested information in said consolidated input.
